(19) United States
(12) Patent Application Publication
(10) Pub. No.: US 2016/0171607 A1
(43) Pub. Date: Jun. 16, 2016

(54) PORTFOLIO MANAGEMENT AND PROTECTION

(71) Applicants: Kandarp R. Acharya, Walnut Creek, CA (US); Christian Chan, Orinda, CA (US)

(72) Inventors: Kandarp R. Acharya, Walnut Creek, CA (US); Christian Chan, Orinda, CA (US)

(73) Assignee: Wells Fargo Bank, N.A., Charlotte, NC (US)

(21) Appl. No.: 14/566,902

(22) Filed: Dec. 11, 2014

(51) Int. Cl. G06Q 40/06

(52) U.S. Cl. CPC G06Q 40/06

(57) ABSTRACT

A short-term forecast volatility may be determined for a portfolio. This short-term forecast volatility may be adjusted by holding futures contracts or derivatives short or long, for example. A number of derivative contracts may be determined to adjust exposure to volatility to compensate for excess or lack of volatility in the short-term. Synthetic put options may be replicated and a put strike generated. Synthetic put options may be replicated for a one year term or other tenor based on delta hedging and a mathematical model, such as a Black-Scholes model, for example. A non-linear function may be selected, such as a power function, to facilitate synthetic put replication. The put strike may be adjusted when a value of the portfolio falls a threshold amount, reaches the put strike value, or is “in the money” (e.g., defined by a delta associated with one or more synthetic put options).

### BACKGROUND

Generally, investors may face different types of risks when investing. For example, adverse events (e.g., a timing risk) may pose a threat to a portfolio of an investor when assets within the portfolio (e.g., having target date funds) are near a lifetime savings peak. In other words, for an investor who is saving for retirement, this period of time (e.g., the lifetime savings peak) would be a period spanning five to ten years prior to retirement or after retirement. Here, in this example, the risk would generally be the greatest for an investor or retiree during this period of time, and thus the investor may transition his or her portfolio to have a conservative asset allocation, such as bond funds, fixed income funds, cash, etc.

Additionally, an investor may manage risks, such as excessive volatility risks, by diversifying his or her portfolio. However, diversification may not provide strong benefits when correlations rise, asset volatilities are high for a sustained period of time, when the market is distressed, etc. Additionally, diversification is a tool that is generally suited better for providing long-term protection to an investor over an extended period of time. In other words, diversification of a portfolio may not protect investors against short-term volatility. Further, there is often an opportunity cost associated with implementing a conservative allocation or asset allocation, such as diversification. For example, if the market does well, an investor with a conservatively managed portfolio (e.g., conservatively allocated) may not realize as many gains as other portfolios.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

In one or more embodiments, one or more techniques or systems for implementing a protection strategy may be provided herein. Volatility management and put protection may be implemented as an overlay on a portfolio, such as an overlay associated with liquid, exchange traded equity and bond futures contracts. As an example, a protection strategy may be implemented as an overlay or as a hedge (e.g., to offset potential losses within a portfolio). In this way, volatility management and put protection may be provided such that adjustment of asset allocations within a portfolio are possible but not necessary when implementing the protection strategy. The protection strategy described herein provides a way for investors to mitigate risks while maintaining gains which would be forfeited by typical or conservatively allocated portfolios.

Volatility management may be provided as part of the protection strategy by reducing exposure of a portfolio to one or more equities, such as stocks, when one or more of the equities exhibit a high degree of volatility (e.g., greater than an upper threshold level of volatility). Conversely, volatility management may be utilized to increase exposure of a portfolio to one or more equities when respective equities exhibit a low level of volatility (e.g., less than a lower threshold level of volatility). In other words, the overall risk within a portfolio or an overall risk associated with a portfolio may be reduced by directly managing the volatility rather than the asset allocation of the portfolio. This may be achieved by adjusting the volatility of the portfolio based on a forecast volatility of the portfolio. Explained another way, a short-term forecast volatility of a portfolio may be managed by dynamically adjusting exposure of the portfolio to risk assets in the portfolio (e.g., utilizing futures or futures contracts). Here, in this example, if a forecast volatility of a portfolio is too high (e.g., greater than an upper threshold volatility associated with the portfolio), one or more actions (e.g., obtaining X number of futures) may be taken to bring the forecast volatility back in line or within a desired range for the forecast volatility, thereby reducing the forecast volatility. Conversely, if a forecast volatility of a portfolio is too low (e.g., less than a lower threshold volatility associated with the portfolio), one or more actions (e.g., to increase exposure) may be taken to bring the forecast volatility within a desired range, thereby increasing the forecast volatility.

Volatility may be measured, calculated, determined, etc. based on one or more capital market expectations, long run expectations of returns, risks, correlations, portfolio history, standard deviations (e.g., of returns) or other statistics of a portfolio, multi-factor risk models, projected or estimated risks or volatilities, etc.

Put protection may be provided as part of the protection strategy by generating one or more synthetic put options based on delta hedging a put with a rolling expiry or rolling put tenor, which may be settled on a frequent basis, such as daily, for example. Stated another way, synthetic exposure to a one year rolling put may be created by a put replication component utilizing delta hedging based on a mathematical model, such as a Black-Scholes model, for example. An initial put strike may be set, such as to 90% of a portfolio value. If the value of the portfolio drops by more than 10% of a peak value of the portfolio, the put strike may be adjusted. The put strike may also be adjusted based on a delta put strike value (e.g., whether or not a put is “deep in the money”). In this way, protection may be provided in the form of an overlay.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example component diagram of a system for portfolio management and protection, according to one or more embodiments.

FIG. 2 is an illustration of an example component diagram of a method for portfolio management and protection, according to one or more embodiments.

FIG. 3 is an illustration of an example computer-readable medium or computer-readable device including processor-executable instructions configured to embody one or more of the provisions set forth herein, according to one or more embodiments.

FIG. 4 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

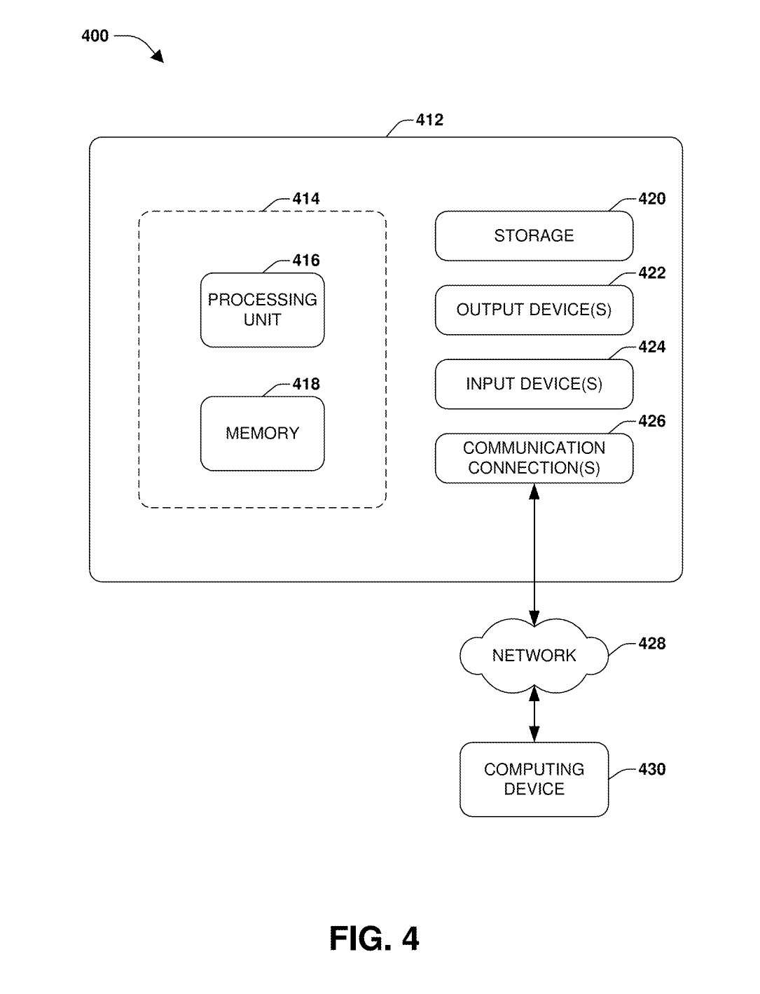

For one or more of the figures herein, one or more boundaries, such as boundary 414 of FIG. 4, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

The following terms are used throughout the disclosure, the definitions of which are provided herein to assist in understanding one or more aspects of the disclosure.

As used herein, a portfolio may include one or more assets, such as equities or stocks. A portfolio may include a mix of assets, such as assets for target date funds, etc. A conventional put may be a financial tool for providing downside protection for an asset. Put replication may be utilized to generate or replicate synthetic puts or one or more synthetic put options which may replicate this downside protection. Derivatives contracts may include futures, forwards, swaps, options, etc.

As used herein, the term “infer” or “inference” generally refer to the process of reasoning about or inferring states of a system, a component, an environment, a user from one or more observations captured via events or data, etc. Inference may be employed to identify a context or an action or may be employed to generate a probability distribution over states, for example. An inference may be probabilistic. For example, computation of a probability distribution over states of interest based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several event and data sources.

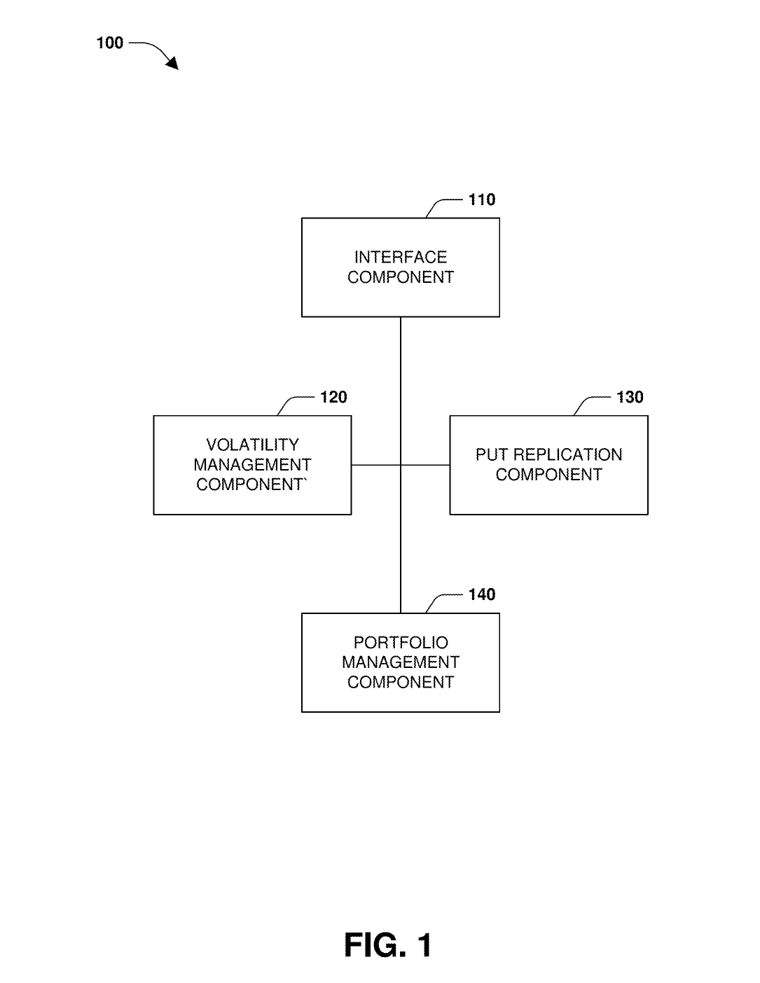

FIG. 1 is an illustration of an example component diagram of a system 100 for portfolio management and protection, according to one or more embodiments. The system 100 for portfolio management and protection may include an interface component 110, a volatility management component 120, a put replication component 130, and a portfolio management component 140. The interface component 110 may receive one or more inputs, such as investor inputs, user inputs, or other inputs etc. An input may include a volatility limit, a volatility band, range, or window. Examples of inputs or user inputs may also include willingness to take risks (e.g., from a scale of 1 to 10), risk level, acceptable volatility, willingness to miss out on upswings in the market, level of protection, etc. In one or more embodiments, a user or investor may provide data, such as a visual representation of desired risks versus rewards and the system 100 may select a function (e.g., non-linear function as described herein) to implement a corresponding protection strategy accordingly.

The volatility management component 120 may reduce exposure of a portfolio to one or more equities, such as stocks, when one or more of the equities is associated with a short-term forecast risk which indicates that one or more of the equities may exhibit a high degree of volatility greater than an upper threshold level of volatility. Conversely, the volatility management component 120 may increase exposure of a portfolio to one or more equities when one or more of the equities is associated with a short-term forecast risk which indicates that one or more of the equities may exhibit a low degree of volatility less than a lower threshold level of volatility. In one or more embodiments, the volatility management component 120 may control or adjust (e.g., obtaining one or more futures contracts associated with one or more of the equities) a volatility associated with a portfolio based on a forecast volatility (e.g., short-term forecast volatility, etc.) of the portfolio. In this way, the volatility management component 120 may dynamically adjust exposure of a portfolio to equities utilizing one or more futures contracts or futures.

As an example, if a forecast volatility of a portfolio is too high (e.g., greater than an upper threshold volatility associated with the portfolio), one or more actions (e.g., obtaining X number of futures contracts) may be taken to bring the forecast volatility back in line or within a desired range for the forecast volatility, thereby reducing the forecast volatility. Conversely, if a forecast volatility of a portfolio is too low (e.g., less than a lower threshold volatility associated with the portfolio), one or more actions (e.g., to increase exposure by holding derivatives short or long) may be taken to bring the forecast volatility within a desired range for the forecast volatility, thereby increasing the forecast volatility.

In one or more embodiments, volatility management may be implemented based on an inverse relationship between volatility and equity returns. Generally, the higher the volatility of a portfolio, the lower the equity returns of the portfolio. Conversely, the lower the volatility, the higher the equity returns may be. By reducing exposure to equities when one or more equities exhibit high volatility (e.g., as indicated by a forecast volatility or short-term forecast volatility), short-term volatility or near-term volatility of a portfolio may be controlled such that the volatility falls within a narrow band, range, or a desirable window, for example. In one or more embodiments, the volatility management component 120 may increase exposure of a portfolio to equities when one or more of the equities exhibit low volatility (e.g., as indicated by the forecast volatility). An input or user input may include a volatility limit, a volatility band, range, or window. This may be expressed as a number (e.g., between 5% and 20%, etc.).

The volatility management component 120 may manage, control, adjust, increase, or decrease such exposure of a portfolio to one or more equities via an overlay. In other words, the volatility management component 120 may manage volatility of a portfolio without requiring adjustment of an asset allocation of the portfolio (e.g., investments, investment choices). Explained yet another way, the volatility management component 120 may manage a portfolio without changing an underlying structure of investments or assets within the portfolio. For example, the volatility management component 120 may overlay one or more derivative contracts (e.g., futures, forwards, swaps, options, etc.) on a portfolio which cause a short-term or near-term volatility forecast of the portfolio to fall within a narrow band, pre-determined range, prescribed range, etc. In this way, the volatility management component 120 may manage exposure to equities and provide a desirable financial outcome for the portfolio, while maintaining the underlying structure of the portfolio (e.g., by not changing the asset allocation of the portfolio).

As an example, if a portfolio has an asset allocation of 60% stock and 40% bonds, the portfolio may be associated with an estimated risk (e.g., volatility) and an estimated return. Here, in this example, the estimated risk or volatility for the portfolio may be 10% the standard deviation of an annual return of the portfolio. In other words, the estimated volatility associated with the portfolio of this example is 10%. However, the estimated volatility is generally more accurate when view or examined in the long run (e.g., an extended period of time, such as over many years), rather than the short run (e.g., a period of time shorter than the extended period of time, such as a few months). To this end, the short-term or near-term volatility of the portfolio may be higher or lower than the estimated volatility or forecast volatility. Here, in this example, the short-term volatility may be 20%, which is higher than the estimated volatility of 10%. This higher short-term volatility may be a result of the equity allocation portion of the portfolio, such as the 60% stock allocation of the portfolio, for example.

In one or more embodiments, the volatility management component 120 may overlay, utilize, or obtain one or more futures contracts or derivative contracts to short the market or index based on a short-term or near-term forecast volatility or estimated volatility being greater than a forecast volatility or estimated volatility (e.g., a long-term forecast volatility). Effectively, the volatility management component 120 may reduce a beta to the market based on obtaining one or more futures contracts or derivative contracts which short the market or otherwise enable an owner of the portfolio to create artificial exposure to risk for assets of a portfolio. In this way, short-term or near-term forecast volatility or estimated volatility may be managed. Here, with respect to operation of the volatility management component 120, no assets are being bought or sold (e.g., asset allocation may remain constant). Rather, a portion of the portfolio (e.g., the equity allocation portion) may be shorted. For example, the volatility management component 120 may short a percentage (e.g., 5%, 10%, etc.) of the Standard & Poor's 500 (S&P 500) index (or other equities of the portfolio). As a result, the short-term forecast volatility of the portfolio may fall.

Regardless, the volatility management component 120 may reduce a beta of the portfolio associated with equities or the stock market by holding these futures or derivative contracts short based on or in response to a short-term volatility or near-term volatility higher than expected. In this way, risk contribution attributed to one or more equities within the portfolio may be mitigated.

In one or more embodiments, the volatility management component 120 may calculate a number of contracts (e.g., derivative contracts or futures contracts) to be held short in order to bring a short-term or near term forecast volatility or estimated volatility within a threshold band or range. In other words, the volatility management component 120 may determine a number of contracts to hold short or long based on a forecast volatility for the portfolio, a short-term forecast volatility for the portfolio, a target volatility, threshold range, etc. When that number of contracts is held short (or long), the short-term forecast volatility of the portfolio may be adjusted such that it falls within the threshold range of the forecast volatility (e.g., long-term forecast volatility) of the portfolio.

As an example, if a target volatility or an estimated volatility for a long-term is 10%, a band or deviation range for the estimated volatility is 2%, then it is acceptable for a current volatility or a realized volatility of the portfolio to be from 8% to 12%. However, if the current volatility or realized volatility of the portfolio rises to 20%, the volatility management component 120 may reduce the exposure of the portfolio to equities by determining a number of contracts to hold short (or long) and shorting that number of futures contracts, thereby bringing the realized volatility of the portfolio to within the 8% to 12% range. Here, the volatility management component 120 may utilize a risk model to facilitate calculation of the number of contracts to short (or hold long) to compensate or adjust the estimated volatility accordingly. In other words, the volatility management component 120 may simulate, estimate, or otherwise quantify a predicted or estimated effect (e.g., shorting or holding long) that a futures contract may have on a portfolio.

Conversely, the volatility management component 120 may hold one or more futures contracts long based on a near-term or short-term forecast volatility or estimated volatility which is less than a forecast volatility or estimated volatility (e.g., over a long-term). In other words, the volatility management component 120 may increase the beta to the market based on holding one or more of the futures contracts long, thereby increasing the near-term or short-term forecast volatility or estimated volatility. In this way, the volatility management component 120 may adjust or control a near-term or short-term forecast volatility or estimated volatility for a portfolio based on one or more futures contracts or derivatives contracts.

In one or more embodiments, the put replication component 130 may create, replicate, or generate one or more synthetic put options based on delta hedging or a forecast volatility associated with a portfolio. Traditionally, put options (e.g., non-synthetic put options) may be created by short-selling an asset while concurrently maintaining a long call position on the same asset. A traditional put option is a device or financial tool which provide an owner of the put option, such as an investor, with the right or the option to sell an underlying asset at a predetermined price (e.g., put strike). In other words, a put option provides downside protection for an asset. Typically, a put option has an expiration date or a maturity date. Generally, put options are utilized as insurance policies against the decline of a stock below a predetermined price. Accordingly, if an investor purchases a put option on an equity, such as a stock, and the same stock subsequently falls in value or becomes worthless, the put option enables the investor to sell his or her shares of that stock and receive at least the price associated with the put strike, thereby providing insurance against the price of the stock falling. Here, in this scenario, when the stock value drops below the strike price or the put strike, the put is “in the money” because the put option would be worth money to an investor (e.g., who owns the stock and the put option associated with the stock). This would enable the investor to sell his or her shares of the stock at a price higher than the price of the stock at market (e.g., similarly to an insurance policy).

The put replication component 130 may generate or replicate one or more synthetic put options which achieve similar results or otherwise provide a cushion against a sudden or large decline in the value of a portfolio. Additionally, one or more of the synthetic put options may utilize futures or derivatives to manage volatility associated with a portfolio, such as a portfolio having one or more target date fund assets.

In one or more embodiments, the short-term forecast volatility of a portfolio may be managed by holding or creating a synthetic put option on the portfolio. The put replication component 130 may implement one or more synthetic put options which effectively create a floor for a value of the portfolio such that no matter what happens to the value of assets of the portfolio or how the market reacts, the value of the portfolio will not drop more than a threshold amount or threshold percentage. This threshold amount or threshold percentage may be indicated by a put strike value or a put strike percentage. In this way, one or more synthetic put options generated by the put replication component 130 may insulate a portfolio from a crisis period or from periods of time where market conditions drop in a tremendous manner, thereby protecting the portfolio against large declines in value, for example. Because these synthetic put options may protect a portfolio against downturns or otherwise mitigate a swing in portfolio value, a swing in volatility, the value of the portfolio utilizing one or more protection strategies described herein may provide smoother changes over time.

Regardless, the put replication component 130 may delta hedge one or more synthetic put options. That is, the put replication component 130 may generate one or more synthetic put options based on delta hedging. For example, the put replication component 130 may analyze the market or current market, a volatility associated with a market, a volatility associated with one or more equities or one or more assets, a current value of one or more equities or one or more assets and hedge or generate one or more synthetic put options accordingly.

The put replication component 130 may hedge one or more synthetic put options based on a rolling expiry (e.g., a one year rolling put, a rolling put tenor, etc.). This means that the put replication component 130 may set or assign an expiry date which ‘rolls’ forward on a daily basis or on another incremental basis. In other words, the put replication component 130 may implement the rolling expiry by implementing a daily settlement for respective synthetic put options. The put replication component 130 may determine a term or a put tenor associated with the rolling expiry. The term of the rolling expiry or the put tenor may be indicative of an amount of protection or an amount of risk an investor is willing to take. In other words, the term of the rolling expiry or the put tenor may be adjusted based on one or more inputs or user inputs, such as willingness to take on risk, etc.

As an example, for a synthetic put option having a one year rolling expiry or a one year put tenor, the put replication component 130 may re-establish delta hedges on a daily basis (e.g., or some other term) such that a synthetic put option is replicated for a one year put. In other words, the put replication component 130 may update, re-establish, or replicate one or more synthetic put options on an incremental basis (e.g., daily, weekly, bi-weekly, monthly, etc.). In this way, the put replication component 130 may generate one or more synthetic put options in perpetuity (e.g., a year into the future), thereby providing delta hedging for one or more of the synthetic put options.

Generally, the delta of one or more synthetic put options may have an inverse relationship with the put tenor. A delta or hedge ratio may be a ratio comparing a change in a price of an asset with a corresponding change in a price of a derivative. As the put tenor or term of the rolling expiry is decreased, delta of one or more of the synthetic put options may increase, thereby providing the investor with better protection or increasing the associated opportunity cost. Conversely, as the term of the rolling expiry or the put tenor is increased, the delta associated with one or more synthetic put options would decrease and provide an investor with less protection, thereby decreasing the associated opportunity cost for the portfolio.

In one or more embodiments, the put replication component 130 may generate one or more synthetic put options based on non-linear delta replication (e.g., utilizing a power function or other non-linear function). In one or more embodiments, delta replication or delta hedging for one or more synthetic put options may be based on a mathematical model, such as a Black-Scholes model, which is a partial differential equation which describes the price of an option (e.g., put option) over time. The mathematical model (e.g., Black-Scholes) may provide a delta for an option or a portfolio. A delta may be indicative of a sensitivity of changes to a value of a portfolio or an asset with respect to changes for another parameter. A larger delta may indicate a larger risk for an associated portfolio or an associated asset, while a smaller delta may indicate a lesser risk.

The put replication component 130 may employ delta replication or delta hedging to one or more synthetic put options in a non-linear fashion. Because the put replication component 130 may employ non-linear delta hedging, less upside may be sacrificed for implementation of downside protection for a portfolio. In other words, because a non-linear function may be utilized for delta replication, such as a power function, synthetic put options may be replicated such that upticks in the market may provide higher returns than replication where a linear model is utilized. Here, a synthetic put option may be replicated based on a portfolio as a whole, rather than utilizing a bit-wise approach. Further, non-linear replication of a delta may be provided by the put replication component 130. Unlike conventional transactions where a bought put is balanced out by a sold put (e.g., a strategy subsidized by selling), replication may not necessarily done one to one.

In one or more embodiments, the put replication component 130 may employ delta replication or achieve delta hedging based on a power function or a mathematical transformation, such as a polynomial, for example. In this example, the put replication component 130 may calculate a delta for a portfolio or a delta for an asset of a portfolio. This delta may be indicative of a manner in which a portfolio will be delta hedged or replicated. In other words, the put replication component 130 may delta hedge one or more synthetic put options based on the calculated delta of a portfolio or an asset. As discussed, because a delta may be indicative of a risk associated with a portfolio, it may be desirable to minimize the delta.

Accordingly, the put replication component 130 may minimize a delta by squaring the delta (e.g., utilizing a power function). As an example, if the delta of a portfolio is 0.1, the put replication component 130 may square the delta, and provide a result of 0.01. Here, in this example, because the delta has been squared (e.g., a power function has been applied), the opportunity-costs associated with the delta have effectively been reduced by a factor of 10. In other words, the opportunity-costs of the delta applied with the power function (e.g., squaring the delta) are one-tenth of the opportunity-costs associated with linear delta replication. In this way, whether markets are declining or markets are on the rise, delta-neutral hedging may be applied. As the delta approaches 1 (e.g., or increases), protection offered by the power function model (e.g., squaring, although other powers or exponents may be utilized) approaches the initial delta value, thereby providing protection when needed (e.g., when risk is high). Conversely, as delta approaches 0 (e.g., or decreases) implementation of a power function enables an investor to take advantage of upswings in the market by decreasing delta accordingly. In one or more embodiments, a power function may be implemented with an exponent between one and two. By varying the exponent for the power function or by selecting different functions, tradeoffs between downturn protection and upswing retention may be made. In one or more embodiments, the put replication component 130 may select a function for an investor based on one or more inputs or user inputs.

In one or more embodiments, the put replication component 130 may select a delta replication function (e.g., different models, functions, power functions, log functions, exponents for respective models, etc.) based on one or more parameters provided by an investor or inputs or user inputs, such as willingness to take risks, risk level, acceptable volatility, willingness to miss out on upswings in the market, level of protection, etc. Examples of different functions may include sine functions, cosine functions, exponential functions, power functions, log functions, sigmoid functions, step functions, etc.

In one or more embodiments, the put replication component 130 may select one or more functions which approximate a delta in a manner such that as the delta (e.g. standard delta) increases or becomes larger, the function approaches the standard delta and as the delta decreases or becomes smaller, the function decreases rapidly in a non-linear fashion. Further, functions may be combined and step functions, or piece-wise functions may be utilized for different ranges of delta. Explained another way, a non-linear function may be selected or designed by the put replication component 130 which has characteristics or attributes tailored or customized to an investors needs or desires. In one or more embodiments, the function may utilize a lookup table, a step function, or other pre-defined value. As an example a function or transform may be selected which takes a delta or standard delta, as calculated based on how the function or transform reacts to inputs or user inputs.

Regardless, the put replication component 130 may generate or replicate one or more synthetic put options or one or more deltas associated with one or more of the synthetic put options and hedge respective synthetic put options based on current market conditions or a rolling expiry.

Additionally, the put replication component 130 may set or assign a put strike for a portfolio or one or more assets of a portfolio. Effectively, a put strike is a threshold value at which synthetic put protection may be implemented (e.g. when a value of a portfolio falls below a floor). For example, a put strike may be set to a percentage of a value of a portfolio (e.g., portfolio value), such as 90%. Here, synthetic put protection utilizing futures may be implemented with an initial put strike of 90%.

In one or more embodiments, the put strike of a portfolio may be adjusted based on the portfolio value or a change in the portfolio value. As an example, if a value of a portfolio increases over time (e.g., steadily rises) and drops a threshold percentage from a peak value of the portfolio (e.g., 10%), the put strike may be adjusted to be or set to 90% of the peak value of the portfolio. Accordingly, by not adjusting the put strike of the portfolio as the value of the portfolio increases (e.g., unless the value drops a threshold from the peak value), drag on the performance of the portfolio may be mitigated. In other words, if the value of the portfolio increases in a manner which does not drop more than a threshold from a peak value of the portfolio, the put replication component 130 does not adjust the value of the put strike or may maintain the value of the put strike such that the put strike value remains constant or substantially the same. By keeping the put strike constant unless a threshold drop in value of the portfolio occurs, the delta of an associated synthetic put option may be reduced, which in turn reduces an effect of drag on the portfolio.

In one or more embodiments, the put replication component 130 may account for multiple peak values for a portfolio. For example, if a portfolio increases in value and hits a first peak value and a first decline causes the portfolio value to decrease more than a threshold associated with a first put strike value, a second put strike value may be assigned. When the portfolio increases in value for a second time (e.g., after the second put strike is assigned), a second peak value may be determined based on the second increase in portfolio value. In other words, the first peak value may be ‘cleared’ when the second put strike is assigned. Explained another way, the first decline in value of the portfolio and the second increase in portfolio value may serve as a trigger to set or adjust the put strike to the second put strike value. Further, a previous peak value may be reset or erased based on a decrease or decline in portfolio value followed by an increase in portfolio value or a drop in portfolio value below a put strike value. In this way, a peak value may be reset or multiple peak values may be accounted for.

The put strike may be adjusted in other scenarios as well. For example, when a put is deep in the money (e.g., when the value of a put, as cash, exceeds a threshold), the put strike may be set to 90% of a current value of the portfolio, hedges sold, and the cash or margin cash may be re invested in the portfolio according to an asset allocation associated with the portfolio. Explained another way, if one or more put options or one or more synthetic put options are part of a portfolio, and the portfolio drops heavily in value, redemption of one or more of those put options or one or more of the synthetic put options may result in cash which becomes part of the portfolio. The put replication component 130 may adjust the put strike based on this cash exceeding a threshold. Further, a portfolio management component 140 may re-invest the cash according to an asset allocation associated with the portfolio.

One example of how this may be achieved would be to reset or adjust a put strike when a put delta or delta associated with a synthetic put option is greater than a threshold percentage, such as 70%. In other words, a put delta or delta associated with a synthetic put option may be determined which may be indicative of whether a put is “deep in the money” (e.g., greater than a threshold, threshold value, or threshold percentage). In one or more embodiments, a put delta limit or a put delta threshold may be set to define when a synthetic put option is “deep in the money”. A put delta may be indicative of how the put value changes for a move in the index. In other words, the put delta may be indicative of how sensitive the put value is with regard to changes in the market in general. As discussed, when the put strike is adjusted in this manner, the portfolio management component 140 may re-invest the cash in the portfolio according to an asset allocation of the portfolio.

Regardless, the put replication component 130 may implement one or more synthetic puts utilizing delta replication based on adjusting a put strike, adjusting a term of a rolling expiry, adjusting a put tenor, or selecting a delta replication function.

In this way, when a volatility of a portfolio is held within a range or a narrow band and providing a cushion for the portfolio when the value of the portfolio falls, returns associated with the portfolio may be smoother as a result. Volatility management may provide smoother returns by mitigating volatility, which results in more consistent equity returns (e.g., based on the inverse relationship between volatility of a portfolio and returns). Additionally, the utilization of managing exposure to equities and synthetic put options may mitigate or reduce a large swings in a value of a portfolio in a more direct manner (e.g., via providing downside protection or a floor below which the value of the portfolio cannot drop, due to the put options). As a result of this, portfolios, such as portfolios for target date funds, may be structured in a manner which relies less on fixed income funds, and thus provide the possibility of lower bond allocations and higher equity allocations for the portfolio. Here, a lower bond allocation may mitigate structural headwinds as rates rise, while higher equity allocations may provide purchasing power or growth opportunities.

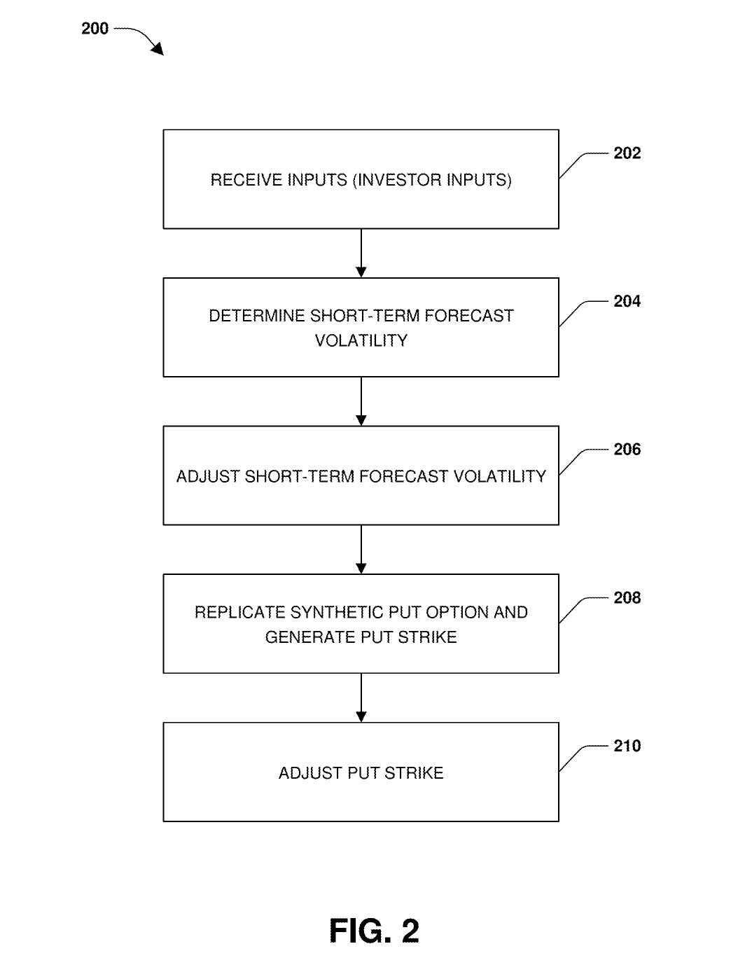

FIG. 2 is an illustration of an example component diagram of a method 200 for portfolio management and protection, according to one or more embodiments. At 202, one or more inputs may be received, such as user inputs or inputs related to acceptable or desirable amounts of risk a portfolio may be exposed to. At 204, a short-term forecast volatility may be determined for a portfolio. This may be based on current market conditions, etc. At 206, the short-term forecast volatility may be adjusted, such as by holding futures contracts (e.g., or other derivatives) short or long, for example. A number of derivative contracts may be determined to adjust exposure to volatility to compensate for excess or lack of volatility in the short-term. At 208, one or more synthetic put options may be replicated and a put strike generated. Synthetic put options may be replicated for a one year term or other tenor based on delta hedging and a mathematical model, such as a Black-Scholes model, for example. A non-linear function may be selected, such as a power function, to facilitate synthetic put replication. The put strike may be adjusted when a value of the portfolio falls a threshold amount, reaches the put strike value, or is “in the money” (e.g., this may be defined by a delta associated with one or more synthetic put options).

One or more embodiments may employ various artificial intelligence (Al) based schemes for carrying out various aspects thereof. One or more aspects may be facilitated via an automatic classifier system or process. A classifier is a function that maps an input attribute vector, x=(x1, x2, x3, x4, xn), to a confidence that the input belongs to a class. In other words, f(x) =confidence (class). Such classification may employ a probabilistic or statistical-based analysis (e.g., factoring into the analysis utilities and costs) to prognose or infer an action that a user desires to be automatically performed.

A support vector machine (SVM) is an example of a classifier that may be employed. The SVM operates by finding a hypersurface in the space of possible inputs, which the hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression utilized to develop models of priority.

One or more embodiments may employ classifiers that are explicitly trained (e.g., via a generic training data) as well as classifiers which are implicitly trained (e.g., via observing user behavior, receiving extrinsic information). For example, SVMs may be configured via a learning or training phase within a classifier constructor and feature selection module. Thus, a classifier may be used to automatically learn and perform a number of functions, including but not limited to determining according to a predetermined criteria.

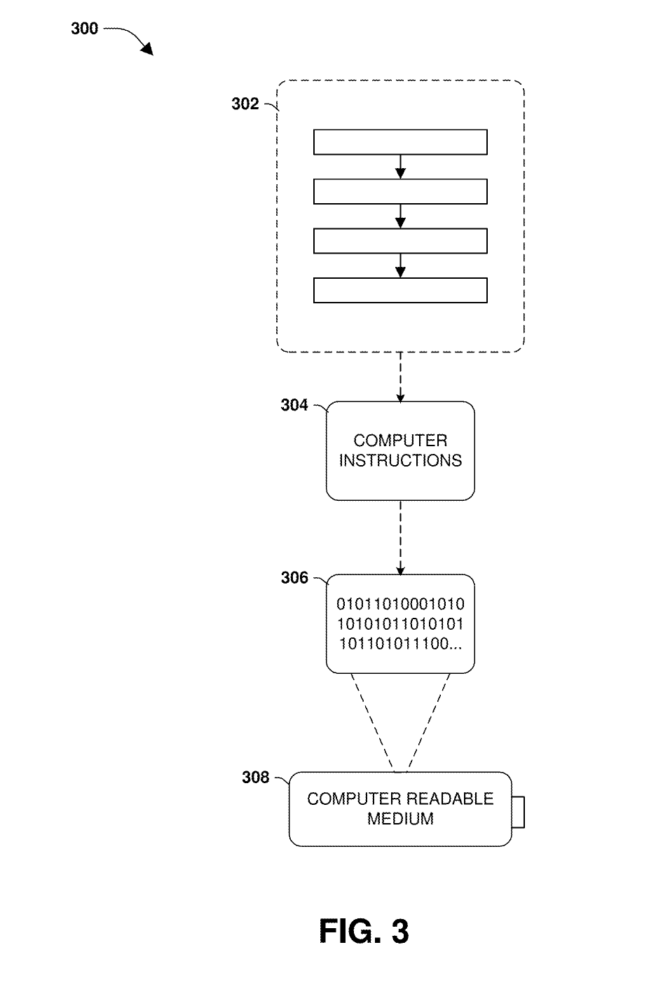

Still another embodiment involves a computer-readable medium including processor-executable instructions configured to implement one or more embodiments of the techniques presented herein. An embodiment of a computer-readable medium or a computer-readable device devised in these ways is illustrated in FIG. 3, wherein an implementation 300 includes a computer-readable medium 308, such as a CD-R, DVD-R, flash drive, a platter of a hard disk drive, etc., on which is encoded computer-readable data 306. This computer-readable data 306, such as binary data including a plurality of zero's and one's as shown in 306, in turn includes a set of computer instructions 304 configured to operate according to one or more of the principles set forth herein. In one such embodiment 300, the processor-executable computer instructions 304 may be configured to perform a method 302, such as the method 200 of FIG. 2. In another embodiment, the processor-executable instructions 304 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 4 and the following discussion provide a description of a suitable computing environment to implement embodiments of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one or more embodiments provided herein. In one configuration, computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other embodiments, device 412 includes additional features or functionality. For example, device 412 may include additional storage such as removable storage or non-removable storage, including, but not limited to, magnetic storage, optical storage, etc. Such additional storage is illustrated in FIG. 4 by storage 420. In one or more embodiments, computer readable instructions to implement one or more embodiments provided herein are in storage 420. Storage 420 may store other computer readable instructions to implement an operating system, an application program, etc. Computer readable instructions may be loaded in memory 418 for execution by processing unit 416, for example.

The term “computer readable media” as used herein includes computer storage media. Computer storage media includes volatile and nonvolatile, removable and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 412. Any such computer storage media is part of device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 412 includes input device(s) 424 such as keyboard, mouse, pen, voice input device, touch input device, infrared cameras, video input devices, or any other input device. Output device(s) 422 such as one or more displays, speakers, printers, or any other output device may be included with device 412. Input device(s) 424 and output device(s) 422 may be connected to device 412 via a wired connection, wireless connection, or any combination thereof. In one or more embodiments, an input device or an output device from another computing device may be used as input device(s) 424 or output device(s) 422 for computing device 412. Device 412 may include communication connection(s) 426 to facilitate communications with one or more other devices.

According to one or more aspects, system for portfolio management and protection is provided, including an interface component, a volatility management component, and a put replication component. The interface component may receive one or more inputs associated with a portfolio of an investor. For example, one or more of the inputs may be user inputs or investor inputs. One or more of the inputs may be a target volatility or a threshold volatility range associated with the portfolio. The portfolio of the investor may include one or more assets. The volatility management component may determine a short-term forecast volatility associated with the portfolio. The volatility management component may adjust the short-term forecast volatility of the portfolio based on the target volatility or threshold volatility range associated with the portfolio by holding one or more derivative contracts short or long or otherwise by obtaining or selling respective contracts. The put replication component may replicating one or more synthetic put options by delta hedging based on a rolling put tenor. The put replication component may generate a put strike associated with one or more of the synthetic put options. The put replication component may adjust the put strike based on a threshold drop in a value of the portfolio or a delta value associated with one or more of the synthetic put options. The system may include a portfolio management component re-investing cash of the portfolio according to an asset allocation for the portfolio based on the delta value associated with one or more of the synthetic put options.

One or more of the assets of the portfolio may be equities. One or more of the derivative contracts may be futures contracts. The volatility management component may determine a number of derivatives contracts to hold short or hold long based on a difference between the target volatility and the short-term forecast volatility. The put replication component may replicate one or more of the synthetic put options based on non-linear replication. For example, the put replication component may select one or more functions for non-linear replication. One or more of the functions may be a sine function, a cosine function, an exponential function, a power function, a log function, a sigmoid function, a step function, a piece-wise function, or a combination thereof. The rolling put tenor is calculated based on one or more of the inputs. For example, the rolling put tenor may be a one year term.

According to one or more aspects, a method for portfolio management and protection is provided, including receiving one or more inputs associated with a portfolio of an investor, wherein the portfolio of the investor comprises one or more assets, wherein one or more of the inputs is a target volatility or a threshold volatility range associated with the portfolio, determining a short-term forecast volatility associated with the portfolio, adjusting the short-term forecast volatility of the portfolio based on the target volatility or threshold volatility range associated with the portfolio by holding one or more derivative contracts short or long, replicating one or more synthetic put options by delta hedging based on a rolling put tenor, generating a put strike associated with one or more of the synthetic put options, or adjusting the put strike based on a threshold drop in a value of the portfolio or a delta value associated with one or more of the synthetic put options. The method may include re-investing cash of the portfolio according to an asset allocation for the portfolio based on the delta value associated with one or more of the synthetic put options.

One or more of the assets of the portfolio may be equities. The method may include determining a number of derivatives contracts to hold short or hold long based on a difference between the target volatility and the short-term forecast volatility. The method may include replicating one or more of the synthetic put options based on non-linear replication or selecting one or more functions for non-linear replication.

According to one or more aspects, system for portfolio management and protection is provided, including an interface component, a volatility management component, and a put replication component. The interface component may receive one or more inputs associated with a portfolio of an investor. For example, one or more of the inputs may be user inputs or investor inputs. One or more of the inputs may be a target volatility or a threshold volatility range associated with the portfolio. The portfolio of the investor may include one or more assets. The volatility management component may determine a short-term forecast volatility associated with the portfolio. The volatility management component may adjust the short-term forecast volatility of the portfolio based on the target volatility or threshold volatility range associated with the portfolio by holding one or more derivative contracts short or long or otherwise by obtaining or selling respective contracts. The put replication component may replicating one or more synthetic put options utilizing non-linear delta hedging based on a rolling put tenor. The put replication component may generate a put strike associated with one or more of the synthetic put options. The put replication component may adjust the put strike based on a threshold drop in a value of the portfolio or a delta value associated with one or more of the synthetic put options. The system may include a portfolio management component re-investing cash of the portfolio according to an asset allocation for the portfolio based on the delta value associated with one or more of the synthetic put options.

The system may include a portfolio management component re-investing cash of the portfolio according to an asset allocation for the portfolio based on the delta value associated with one or more of the synthetic put options. One or more of the assets of the portfolio may be equities. One or more of the derivative contracts may be futures contracts.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for portfolio management and protection, comprising:
an interface component receiving one or more inputs associated with a portfolio of an investor, wherein the portfolio of the investor comprises one or more assets, wherein one or more of the inputs is a target volatility or a threshold volatility range associated with the portfolio;
a volatility management component:
determining a short-term forecast volatility associated with the portfolio; and
adjusting the short-term forecast volatility of the portfolio based on the target volatility or threshold volatility range associated with the portfolio by holding one or more derivative contracts short or long; and
a put replication component:
replicating one or more synthetic put options by delta hedging based on a rolling put tenor;
generating a put strike associated with one or more of the synthetic put options; and
adjusting the put strike based on a threshold drop in a value of the portfolio or a delta value associated with one or more of the synthetic put options,
wherein the interface component, the volatility management component, or the put replication component is implemented via a processing unit.

2. The system of claim 1, comprising a portfolio management component re-investing cash of the portfolio according to an asset allocation for the portfolio based on the delta value associated with one or more of the synthetic put options.

3. The system of claim 1, wherein one or more of the assets of the portfolio are equities.

4. The system of claim 1, wherein one or more of the derivative contracts are futures contracts.

5. The system of claim 1, wherein the volatility management component determines a number of derivatives contracts to hold short or hold long based on a difference between the target volatility and the short-term forecast volatility.

6. The system of claim 1, wherein the put replication component replicates one or more of the synthetic put options based on non-linear replication.

7. The system of claim 1, wherein the put replication component selects one or more functions for non-linear replication.

8. The system of claim 7, wherein one or more of the functions is a sine function, a cosine function, an exponential function, a power function, a log function, a sigmoid function, a step function, a piece-wise function, or a combination thereof.

9. The system of claim 1, wherein the rolling put tenor is a one year term.

10. The system of claim 1, wherein the rolling put tenor is calculated based on one or more of the inputs.

11. A method for portfolio management and protection, comprising:
receiving one or more inputs associated with a portfolio of an investor, wherein the portfolio of the investor comprises one or more assets, wherein one or more of the inputs is a target volatility or a threshold volatility range associated with the portfolio;
determining a short-term forecast volatility associated with the portfolio;
adjusting the short-term forecast volatility of the portfolio based on the target volatility or threshold volatility range associated with the portfolio by holding one or more derivative contracts short or long;
replicating one or more synthetic put options by delta hedging based on a rolling put tenor;
generating a put strike associated with one or more of the synthetic put options; and
adjusting the put strike based on a threshold drop in a value of the portfolio or a delta value associated with one or more of the synthetic put options,
wherein the receiving, the determining, the replicating, the generating, or the adjusting is implemented via a processing unit.

12. The method of claim 11, comprising re-investing cash of the portfolio according to an asset allocation for the portfolio based on the delta value associated with one or more of the synthetic put options.

13. The method of claim 11, wherein one or more of the assets of the portfolio are equities.

14. The method of claim 11, comprising determining a number of derivatives contracts to hold short or hold long based on a difference between the target volatility and the short-term forecast volatility.

15. The method of claim 11, comprising replicating one or more of the synthetic put options based on non-linear replication.

16. The method of claim 11, comprising selecting one or more functions for non-linear replication.

17. A system for portfolio management and protection, comprising:
an interface component receiving one or more inputs associated with a portfolio of an investor, wherein the portfolio of the investor comprises one or more assets, wherein one or more of the inputs is a target volatility or a threshold volatility range associated with the portfolio;
a volatility management component:
determining a short-term forecast volatility associated with the portfolio; and
adjusting the short-term forecast volatility of the portfolio based on the target volatility or threshold volatility range associated with the portfolio by holding one or more derivative contracts short or long; and
a put replication component:
replicating one or more synthetic put options utilizing non-linear delta hedging based on a rolling put tenor;
generating a put strike associated with one or more of the synthetic put options; and
adjusting the put strike based on a threshold drop in a value of the portfolio or a delta value associated with one or more of the synthetic put options,
wherein the interface component, the volatility management component, or the put replication component is implemented via a processing unit.

18. The system of claim 17, comprising a portfolio management component re-investing cash of the portfolio according to an asset allocation for the portfolio based on the delta value associated with one or more of the synthetic put options.

19. The system of claim 17, wherein one or more of the assets of the portfolio are equities.

20. The system of claim 17, wherein one or more of the derivative contracts are futures contracts.
